(19) United States
(12) Patent Application Publication
(10) Pub. No.: US 2026/0261326 A1
(43) Pub. Date: Sep. 3, 2026

(54) COMMUNICATION NETWORK

(71) Applicant: Nokia Technologies Oy, Espoo (FI)

(72) Inventors: Rafhael MEDEIROS DE AMORIM, Aalborg (DK); Jeroen WIGARD, Klarup (DK); Mads LAURIDSEN, Gistrup (DK); Simon SVENDSEN, Aalborg (DK); Christian ROM, Aalborg (DK)

(73) Assignee: Nokia Technologies Oy, Espoo (FI)

(21) Appl. No.: 18/879,954

(22) PCT Filed: Jul. 1, 2022
(86) PCT No.: PCT/EP2022/068296

§ 371 Date: Dec. 30, 2024

(51) Int. Cl. H04B 7/155

(52) U.S. Cl. CPC H04B 7/15507

(57) ABSTRACT

An apparatus of a non-terrestrial radio access network assigns a signature to one or more repeater devices after the one or more repeater devices had been connected to the apparatus, and broadcasts position information regarding a position of the one or more repeater devices and an indication of the signature of the one or more repeater devices. A user equipment detects at least one specific variation regarding bursts received by the user equipment, compares one or more predetermined signatures to the at least one specific variation and, in case a predetermined signature of the one or more predetermined signatures corresponds to the at least one specific variation, identifies a connection to a non-terrestrial radio access network via a repeater device that has been assigned the predetermined signature.

### TECHNICAL FIELD

At least some example embodiments relate to a communication network, in particular a non-terrestrial network (NTN).

### BACKGROUND

In most cellular systems, several users may be connected to one base station, as they may be allocated to different time and frequency resources. For guaranteeing that the signals from different users do not interfere to each other in uplink (UL), spilling over in time and frequency into resources allocated to other users, it is a requirement that the user equipments (UEs) are synchronized, e.g. time and frequency aligned to each other.

In terrestrial networks (TN), where the frequency deviations experienced by the users are usually not significant, the difference in the propagation time for the signals to arrive at the base station when transmitted by different UEs may vary considerably, depending on their relative positions to the base station. To compensate for that, UEs are required to perform timing advance.

The timing advance applied to each individual UE is estimated by the gNB after a Random Access procedure. After this point the network may issue timing advance commands to maintain the time alignment of the UE.

However, before the Random Access, regular UEs are not aware of magnitude of the propagation delay, so no timing advance is applied. Because of this, Random Access (RA) resources are usually more robust to time and frequency impairments, and they utilize a set of predefined preamble sequences in order to enable more robust reception by the base station side.

In NTN (non-terrestrial networks), the common delays observed between the UE and a satellite at hundreds of kilometers of distance are much larger than those typically observed at TN. As a consequence, the RA preambles and RACH procedure as from TN are not designed to enable a correct detection of the RA attempt and a proper round-trip delay estimation. Moreover, for LEO (low-Earth orbit) satellite types (at altitudes of 300-1500 km), the ultra-high speeds observed—in the order of approximately 7.5 kilometers/second-cause the delay to vary rapidly. Because of this, the delay corrections cannot be managed by the legacy procedures and more advanced delay estimation procedures are needed; additionally, the amount of timing advance commands required for maintaining such connection would create a massive overhead in the physical layer resources.

It has been decided to incorporate GNSS (global navigation satellite system) usage by the UE in order to allow the delay estimation prior to and after the Random Access procedure. Corresponding agreements indicate UE will determine satellite position by the ephemeris information broadcasted by the base station, and estimate the delay to the UE position, acquired via GNSS. The agreements include but are not limited to:
UE can derive based on its GNSS implementation one or more of:
   its position
   a reference time and frequency.
And, based on one or more of these elements together with additional information (e.g., serving satellite ephemeris or timestamp) signaled by the network, UE can compute timing and frequency, and apply timing advance and frequency adjustment at least for UE in RRC idle/inactive mode.
An NTN UE in RRC_IDLE and RRC_INACTIVE states is required to at least support UE specific TA calculation based at least on its GNSS-acquired position and the serving satellite ephemeris.
An NTN UE in RRC_CONNECTED state is required to support UE specific TA calculation based at least on its GNSS-acquired position and the serving satellite ephemeris.

NTNs are expected to serve remote and underserved areas, among other applications. In this sense, the UEs may be located in energy-constrained locations. This makes the inefficient usage of UE power a serious problem to be addressed. Moreover, there are several services, most importantly IoT over NTN, where several low-cost UEs may be in a given geographical area, such as a container ship, a network of sensors in a jungle/island, etc.

Furthermore, NTN has been seen by many players as the solution for serving third world countries with Internet access. This means for example providing coverage in remote villages, located in underserved areas or areas with lack of infrastructure. Installing full cellular towers is too expensive. NTN solutions suffers from being unable to serve indoor users, as GNSS coverage lacks indoor and from poor data rates for handhelds.

Turning on the GNSS RF circuitry for acquiring UE position frequently may lead to waste of power, in particular considering that a UE waking up from deep sleep state may take several seconds before acquiring its position. For example, a GNSS warm start (where UE has almanac, but no ephemeris) requires about 30 seconds, while a hot start (where UE has both almanac and ephemeris) requires 1-5 seconds.

The low-cost UEs are also affected by the fact that the GNSS and the cellular modem share RF-chain components in several marketed devices. Therefore, acquiring GNSS position means the UE is unavailable for receiving/transmitting 5G NR signals transmitted over NTN. This will increase even more the amount of time the UE needs to be awake for finalizing one operational cycle. Furthermore, a UE may not be able to operate GNSS and 3GPP radios simultaneously.

### LIST OF ABBREVIATIONS

3GPP Third Generation Partnership Project
5G Fifth Generation
C plane Control plane
DL Downlink
gNB 5G NodeB, next Generation Node B
GNSS Global Navigation Satellite System
GW Gateway
IoT Internet of Things
MIB Master Information Block
NCR Network Controlled Repeater
NR New Radio
NTN Non-Terrestrial Network
OTA Over The Air
OTDOA Observed Time Difference On Arrival
PDP Power Delay Profile
PSS Primary Synchronization Signal
RA Random Access
RF Radio Frequency
RRC Radio Resource Control
RSRP Reference Signal Received Power
SI System Information
SIB System Information Block
SSB Synchronization Signal Block
SSS Secondary Synchronization Signal
TN Terrestrial Network
UE User Equipment
UL Uplink
U plane User plane

### SUMMARY

At least some example embodiments aim at eliminating UE dependency on GNSS for UE pre-compensation of time and frequency in NTNs.

According to at least some example embodiments, this is achieved by the methods, apparatuses and non-transitory computer-readable storage media as specified by the appended claims.

At least some example embodiments provide for a cost-efficient solution including indoor coverage.

According to at least some example embodiments, tracking of satellite movement and signal, high transmission power in uplink, limited indoor/in-jungle coverage due to lack of GNSS support, excessive use of GNSS, etc. can be avoided, alleviating stringent power consumption on NTN users.

At least some example embodiments enable a new framework for NTN UEs with minimized reliance on GNSS.

At least some example embodiments do not alter the behavior of legacy UEs and UEs that decide to ignore the information provided by the gNB.

According to at least some example embodiments, overhead in the physical interface is very small.

In the following some example embodiments will be described with reference to the accompanying drawings.

### BRIEF DESCRIPTION OF THE DRAWINGS

FIG. 1 shows flowcharts illustrating processes 1 and 2 according to at least some example embodiments.

FIG. 2 shows a diagram illustrating an NTN scenario.

FIG. 3 shows a signaling diagram illustrating signaling according to at least some example embodiments.

FIG. 4 shows a flowchart illustrating a UE procedure for identifying NTN-NCR according to at least some example embodiments.

FIG. 5 shows a diagram illustrating different scenarios for applying at least some example embodiments.

FIG. 6 shows a diagram illustrating NTN-NCR identification according to at least some example embodiments.

FIG. 7 shows a diagram illustrating NTN-NCR identification according to at least some example embodiments.

FIG. 8 shows a schematic block diagram illustrating a configuration of control units in which example embodiments are implementable.

### DESCRIPTION OF THE EMBODIMENTS

In at least some example embodiments, a repeater device such as an RF repeater which has been used e.g. in 2G, 3G and 4G deployments for improving network coverage is utilized.

According to at least some example embodiments, the repeater device is a non-regenerative type of relay node that amplifies-and-forwards transmissions it has received. According to at least some example embodiments, the repeater device is a full-duplex node.

According to at least some example embodiments, the repeater device is a terrestrial device that provides repetitions of transmissions.

According to at least some example embodiments, the repeater device relays an NTN signal in a given area, for example, a village in a remote location, out of a terrestrial network grid, a container ship, or areas monitored by sensors on a preserved jungle/forest.

In the following, the repeater device also is referred to as “NTN Intelligent Repeater” or NTN-NCR (network controlled repeater).

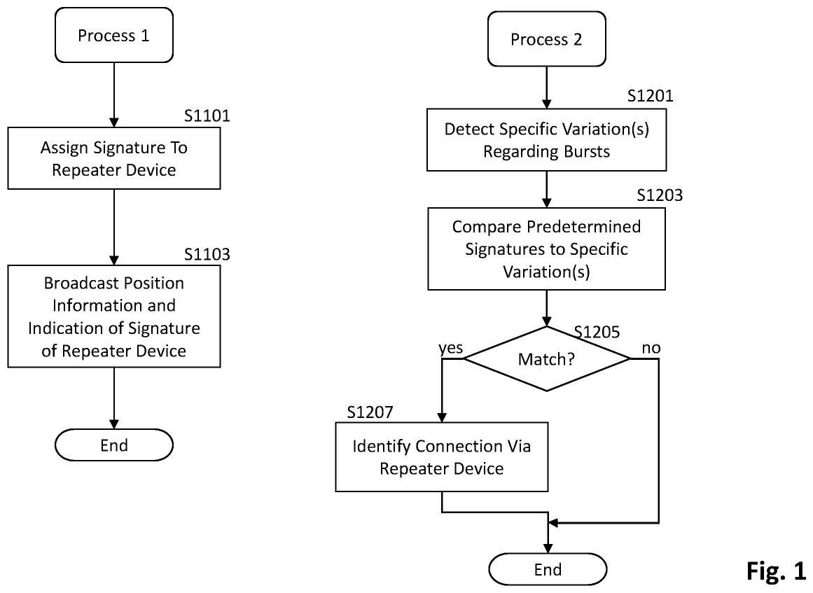

Now reference is made to FIG. 1 showing flowcharts which illustrates processes 1 and 2 according to at least some example embodiments. Process 1 will be described below, and process 2 will be described later on.

According to at least some example embodiments, the process 1 is executed by an apparatus of a non-terrestrial radio access network. According to at least some example embodiments, the apparatus is a base station, e.g. an eNB, gNB, which is located at a satellite or gateway of an NTN.

According to at least some example embodiments, process 1 is triggered when a repeater device is connected to the apparatus and/or when the repeater device is configured.

After process 1 was triggered, it advances to step S1101 in which a signature is assigned to a repeater device after the repeater device had been connected to the apparatus. Then, process 1 advances to step S1103.

In step S1103, position information regarding a position of the repeater device and an indication of the signature assigned to the repeater device in step S1101 are broadcast. Then, process 1 ends.

According to at least some example embodiments, in step S1103, polarization information regarding a polarization configuration associated with the repeater device is broadcast.

According to at least some example embodiments, process 1 is executed for several or a plurality of repeater devices.

According to at least some example embodiments, the signature is unique for each of the one or more repeater devices associated with the apparatus.

According to at least some example embodiments, the signature comprises a pattern of downlink transmissions to be performed, by the one or more repeater devices, as repetitions of transmissions which are received by the one or more repeater devices from the apparatus.

According to at least some example embodiments, the signature comprises an on/off pattern of downlink transmissions for each of the one or more repeater devices.

According to at least some example embodiments, the signature, for each of the one or more repeater devices, comprises an on/off pattern of downlink transmissions to be performed, by the one or more repeater devices, as repetitions of transmissions which are received by the one or more repeater devices from the apparatus, the on/off pattern being associated with at least one of full slots, subframes, symbols, a bandwidth part, a subset of bandwidth parts or any downlink reference structure comprising at least one of synchronization signal blocks, primary synchronization signals, secondary synchronization signals, or channel status information.

According to at least some example embodiments, the signature, for each of the one or more repeater devices, comprises a sequence of downlink transmissions to be performed, by the one or more repeater devices, as repetitions of transmissions which are received by the one or more repeater devices from the apparatus, wherein, according to the sequence, in some predefined occasions, the repetitions are to be turned off.

According to at least some example embodiments, the indication of the signature comprises a list of the repeater devices each associated with its position information and unique signature.

According to at least some example embodiments, the one or more repeater devices comprise a radio frequency signal repeater.

According to at least some example embodiments, the one or more repeater devices comprise an analog repeater.

According to at least some example embodiments, the one or more repeater devices are terrestrial.

According to at least some example embodiments, the one or more repeater devices are stationary and the position information comprises a single position.

According to at least some example embodiments, the one or more repeater devices are moving and the position information comprises at least one position and a time corresponding to the at least one position.

According to at least some example embodiments, the one or more repeater devices are for providing repetitions of transmissions.

According to at least some example embodiments, the apparatus of the non-terrestrial radio access network obtains the position of the one or more repeater devices, e.g., directly from the one or more repeater devices, via a core network, or via a location and management function of a core network. According to at least some example embodiments, the apparatus of the non-terrestrial radio access network determines the position of the one or more repeater devices based on positioning methods.

According to at least some example embodiments, the apparatus of the non-terrestrial radio access network determines the position of the one or more repeater devices based on observed time difference on arrival, OTDOA.

According to at least some example embodiments, the apparatus of the non-terrestrial radio access network receives an update of the position from the one or more repeater devices.

According to at least some example embodiments, the apparatus of the non-terrestrial radio access network configures the one or more repeater devices, when the one or more repeater devices are being connected to the apparatus.

According to at least some example embodiments, the apparatus of the non-terrestrial radio access network configures the signature for the one or more repeater devices, when the one or more repeater devices are being connected to the apparatus.

According to at least some example embodiments, the apparatus of the non-terrestrial radio access network configures the one or more repeater devices, when the one or more repeater devices are being connected to the apparatus, by setting a transmission power of repetitions, to be performed by the one or more repeater devices, of transmissions which are received by the one or more repeater devices, towards the apparatus and one or more user equipments. According to at least some example embodiments, in step S1101 of process 1, after an NTN Intelligent Repeater is connected and configured to an NTN base station (e.g. gNB), the NTN base station acquires the position of the NTN Intelligent Repeater, and assigns a signature (also referred to as a “repeater signature” in the following) to the NTN Intelligent Repeater. The repeater signature is unique for each NTN Intelligent Repeater associated with the NTN base station.

According to at least some example embodiments, the signature is an on/off pattern of the repetitions (of the gNB transmissions) either from full slots or subframes or from specific resources. According to at least some example embodiments, the NTN intelligent repeater has a “puncture pattern” (also referred to as “puncturing pattern” in the following) of the repetition on synchronization blocks (SSBs), stating that in some predefined occasions, the repetition of the synchronization blocks will be turned off.

According to at least some example embodiments, in step S1103 of process 1, the base station includes the position information and the indication of the signature of the NTN Intelligent Repeater(s) in a broadcast SI message.

Then, clever UE implementations may use the repetitions from the NTN Intelligent Repeater(s) and the information broadcast by the base station such that the UE can identify the presence of the NTN Intelligent Repeater and utilize the information for refined positioning (for example, by assuming the position of the NTN Intelligent Repeater). The specific details of how the UE identifies the presence of the NTN Intelligent Repeater based on the intelligent repeater signature will be described later on.

It is noted that process 1 does not disable the NTN Intelligent Repeater or any of its other functionalities to legacy UEs, that are unaware of the meaning of the broadcasted information, because the NTN Intelligent Repeater in principle is not visible to the UEs. However, legacy UEs would still have to rely on GNSS for acquiring pre-compensation parameters. The set of UE actions and the UE implementation for identifying the signature will be described later on.

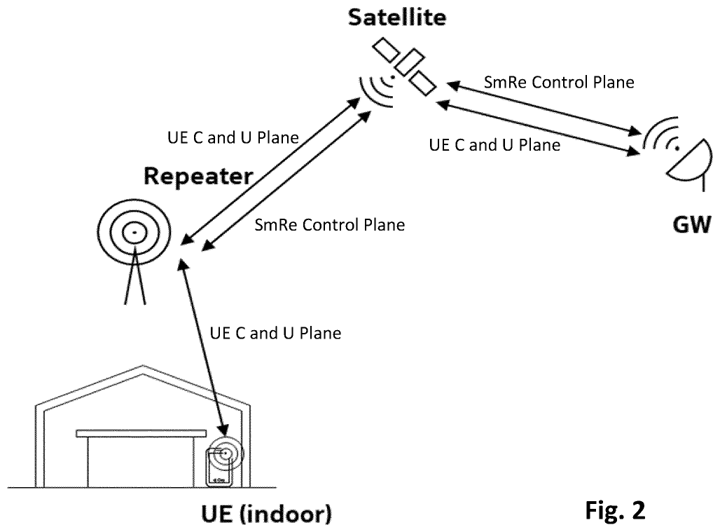

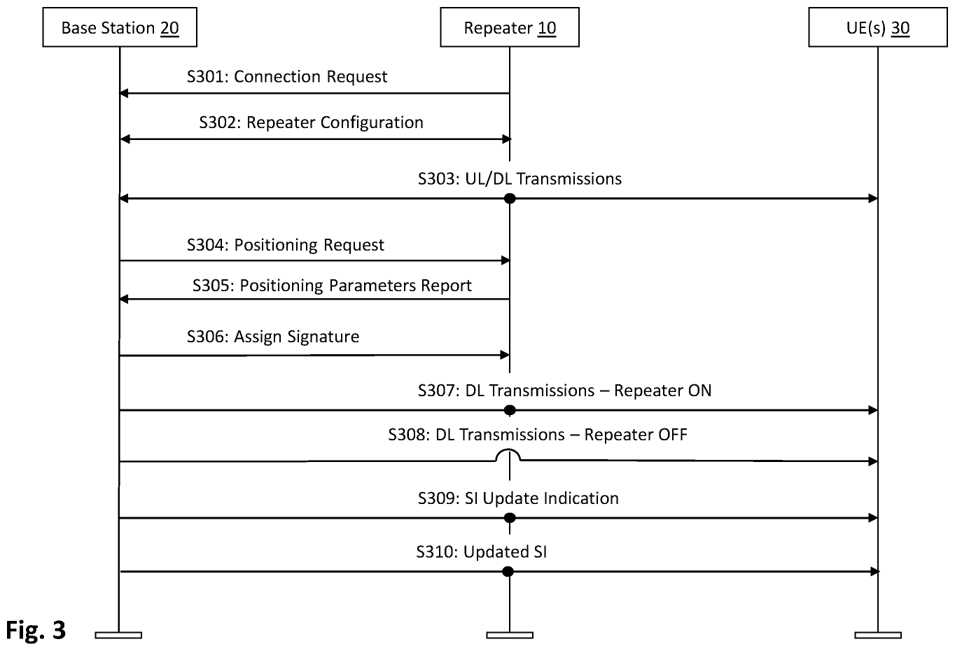

FIG. 2 shows a diagram illustrating an NTN scenario addressed by at least some example embodiments, and FIG. 3 shows a signaling diagram illustrating signaling according to at least some example embodiments.

As a starting point, UEs (UE shown in FIG. 2, UE(s) 30 shown in FIG. 3) are not aware of the presence of an NTN Intelligent Repeater (indicated as “Repeater” in FIG. 2 and “repeater 10” in FIG. 3). As shown in FIG. 2, there is ongoing signaling between a base station (base station 20 according to FIG. 3) which is located either at a satellite or a gateway (GW), and the NTN Intelligent Repeater. The NTN Intelligent Repeater, however, cannot modify the contents of the encapsulated messages (e.g. on UE C and U planes) it repeats (i.e. amplifies and forwards).

In step S301 of FIG. 3, the repeater 10 transmits a connection request to the base station 20, and in step S302 the repeater 10 is configured. In other words, in steps S301 and S302, the repeater 10 sets up connection with the base station 20. For example, the connection is set up via an SmRe (Smart Receiver) control plane illustrated in FIG. 2.

After the repeater 10 was configured, the repeater 10 already is able to repeat and amplify UL and DL transmissions (step S303) between the base station 20 and the UE(s) 30 as a TN Repeater would do. At this point, UL transmissions are only available for UEs in connected mode, which were able to get access by acquiring positioning information from other sources (e.g. GNSS) and are not aware of the presence of the NTN Intelligent Repeater 10.

For example, the base station 20 acquires the position of the NTN Intelligent Repeater 10 by issuing a positioning request (step S304) and receiving a positioning parameters report (S305), e.g. by using signaling via the SmRe control plane illustrated in FIG. 2.

The method for acquiring the positioning report may vary and uses one or more of the following:
A Location and Management Function (LMF) in charge of acquiring and managing the NTN Intelligent Repeater position. Alternatively, the position is stored locally in the eNB/gNB, which is connected with the satellite providing coverage in the area of the NTN Intelligent Repeater.
The positioning parameters report contains the NTN Intelligent Repeater position, which can be obtained by the NTN Intelligent Repeater by different means (GNSS, external sources, hard-coded, etc.).
The positioning parameters report contains measurements reported to be translated into a position by the base station (for example, for some network based positing methods).

For example, the NTN Intelligent Repeater indicates to the network that it is stationary (e.g. if it is located at a fixed position in a village). Therefore, the location is only exchanged once and not when the next satellite provides coverage in the area. If the NTN Intelligent Repeater is moving (e.g. if it is mounted on a ship) the NTN Intelligent Repeater has to trigger location updates towards the network, which will then also have to update the broadcasted SI.

In step S306, the base station 20 assigns a repetition signature for the NTN Intelligent Repeater 10, e.g. via the SmRe control plane illustrated in FIG. 2.

According to at least some example embodiments, the repetition signature is a pattern of DL transmission (or repetition) that is performed at the NTN Intelligent Repeater 10. According to at least some example embodiments, the signature is an “ON/OFF” pattern for the repeater 10.

According to at least some example embodiments, according to the signature, one SSB-index or a subset of SSB-indexes of a cell is uniquely associated with the NTN Intelligent Repeater 10. No other NTN Intelligent Repeater is able to repeat this SSB-index/these SSB-indices, nor can the NTN Intelligent Repeater 10 repeat other SSBs.

According to at least some example embodiments, the signature is a puncture pattern on subframes. For example, every 2nd subframe is blanked (not-repeated) at the NTN Intelligent Repeater 10. Alternatively, the puncture pattern provides a formula to indicate which subframes are not repeated.

According to at least some example embodiments, the signature is a puncture pattern on PSS and SSS resources. For example, similarly as above, the signature is a pattern to indicate at which occasions the PSS and SSS resources are repeated or not.

According to at least some example embodiments, the signature is a puncture pattern on the SSBs (SIBs). For example, the satellite will broadcast SSBs with one periodicity, while the NTN Intelligent Repeater 10 broadcasts with a different, longer periodicity, i.e., it does not repeat all the SSBs from the satellite.

According to at least some example embodiments, according to the signature, one bandwidth part or a subset of bandwidth parts is/are repeated by the NTN Intelligent Repeater 10 whereas others are not. According to at least some example embodiments, this is performed by the repeater 10 either statically or dynamically varying over time, based on the signature assigned by the base station 20.

Then, DL transmissions where the NTN Intelligent Repeater 10 is “ON” (the puncture pattern is indicated as active) are repeated as shown by step S307, whereas DL transmissions where the NTN Intelligent Repeater 10 is “OFF” are not repeated as shown by step S308, and they are available for the UEs 30 only if the UEs 30 can listen to the signals transmitted directly from the base station 20 via satellite.

It is noted that uplink transmissions by the UEs 30 in connected mode are carried (e.g. amplified and forwarded) by the repeater 10 as normal, i.e. without applying any signature (puncture pattern).

In step S309, the base station 20 sends an SI (System Information) update indication, notifying the UEs 30 that an update on the SI is expected.

In the next modification window, the SI is updated (S310). According to at least some example embodiments, the base station 20 includes the position and puncture pattern of the NTN Intelligent Repeater 10 in the new version of the SI.

According to at least some example embodiments, this information is included in NTN SI, a new SI (e.g. NTN Intelligent Repeater SI) or any other SI (for example, for applications outside NTN).

According to at least some example embodiments, the information (parameter) contains a list of NTN Intelligent Repeaters each associated to a different NTN Intelligent Repeater signature.

At the UE side, after the UE receives the SI transmission, the UE is aware of the presence of the NTN Intelligent Repeater. At this point clever UE implementations may use this information to gather more (or refined) information about its position. It allows indoor UEs one more chance to get connectivity, while energy-constrained UEs may use this information for deciding on a more conservative/frugal use of GNSS.

According to at least some example embodiments, a new framework for NTN UEs with minimized reliance on GNSS is enabled. Further, the above described solution does not alter the behavior of legacy UEs and UEs that decide to ignore the information provided by the gNB (base station). Still further, overhead in the physical interface is very small.

Now reference is made again to FIG. 1 and process 2 which is executed by a user equipment (UE). For example, process 2 is started when the UE is turned on or a specific application of the UE is turned on.

In step S1201, at least one specific variation regarding bursts received by the user equipment is detected. Then, process 2 advances to step S1203.

In S1203, one or more predetermined signatures are compared to the at least one specific variation. Then, process 2 advances to step S1205.

In S1205 it is determined whether or not a predetermined signature of the one or more predetermined signatures corresponds to the at least one specific variation.

In case a predetermined signature of the one or more predetermined signatures corresponds to the at least one specific variation (yes in S1205), process 2 advances to S1207 in which a connection to a non-terrestrial radio access network via a repeater device that has been assigned the predetermined signature is identified. Then, process 2 ends.

In case no match is found in S1205 (no in S1205), process 2 ends.

According to at least some example embodiments, the at least one specific variation comprises at least one out of the following: power variation, power delay profile variation, and polarization variation.

According to at least some example embodiments, in case the specific variation is the power variation of bursts, in S1201, the predetermined signature is detected based on a change in received power level of the bursts.

According to at least some example embodiments, in case the specific variation is the power delay profile variation, in S1201, the predetermined signature is detected by correlating delay differences between the bursts to the one or more predetermined signatures.

According to at least some example embodiments, in case the specific variation is the polarization variation, in S1201, the predetermined signature is detected based on a polarization of the bursts.

According to at least some example embodiments, the bursts are associated with at least one out of the following: full slots, subframes, symbols, a bandwidth part, a subset of bandwidth parts or any downlink reference structure comprising at least one of synchronization signal blocks, primary synchronization signals, secondary synchronization signals, or channel status information.

According to at least some example embodiments, each of the one or more predetermined signatures comprises a pattern of downlink transmissions to be performed, by the repeater device that has been assigned the predetermined signature, as repetitions of transmissions which are received by the repeater device from an apparatus of the non-terrestrial radio access network.

According to at least some example embodiments, the predetermined signature comprises an on/off pattern of the downlink transmissions.

According to at least some example embodiments, the on/off pattern is associated with at least one of full slots, subframes, symbols, a bandwidth part, a subset of bandwidth parts or any downlink reference structure comprising at least one of synchronization signal blocks, primary synchronization signals, secondary synchronization signals, or channel status information.

According to at least some example embodiments, each of the one or more predetermined signatures comprises a sequence of downlink transmissions to be performed, by the repeater device that has been assigned the predetermined signature, as repetitions of transmissions which are received by the repeater device from an apparatus of the non-terrestrial radio access network, wherein, according to the sequence, in some predefined occasions, the repetitions are to be turned off.

A UE implemented with the procedure of process 2 can use the information of specific puncturing patterns of the SSB bursts and information of GNSS coordinates of the NTN-NCR as described above to obtain/refine its positioning solutions, by identifying the presence of the NTN-NCR. In addition, the solution does not disable the NTN-NCR or any of its other functionalities to legacy UEs, that are unaware of the meaning of the broadcasted parameter, because the NTN-NCR in principle is not visible to the UE. However, legacy UEs would still have to rely on GNSS for acquiring pre-compensation parameters. At least some example embodiments focus on NR implementation, but the procedure will also be valid for LTE systems where the LTE Synchronization Signal Block is repeated in a puncturing pattern at the NTN-NCR.

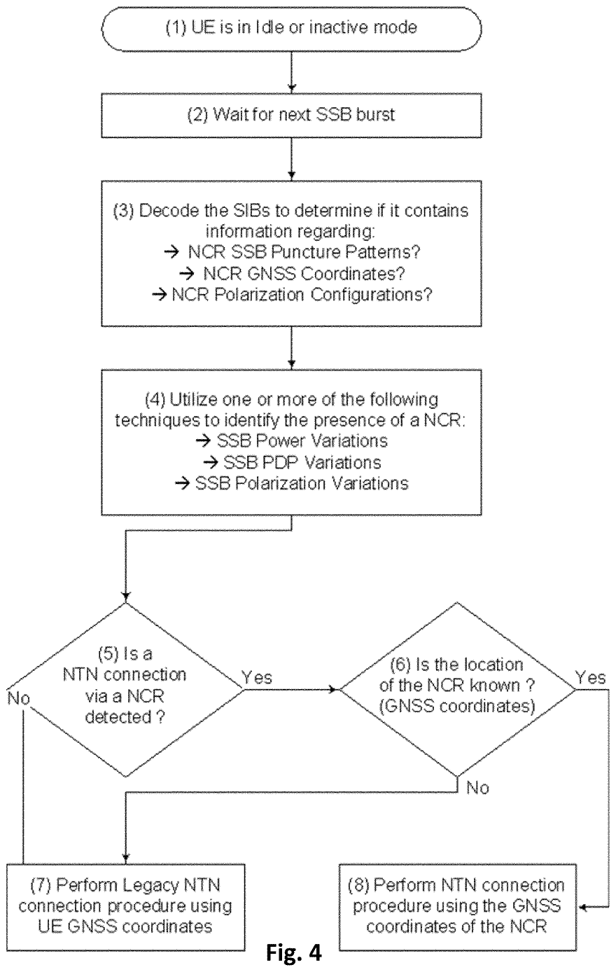

A UE procedure for identifying an NTN-NCR according to at least some example embodiments is shown in FIG. 4.

In step (1), the UE is assumed to be in RRC, idle or inactive mode when entering this UE procedure and the UE will have to know its GNSS position before it can attempt to setup a connection to the gNB. As such, if an idle UE can get the GNSS information of the NTN-NCR it can save some power as it doesn't have to keep track of its own position and can keep its GNSS receiver switched off, or alternatively, the UE may not even be implemented with a GNSS receiver.

In step (2), the UE will wait for the next NTN SSB bursts.

In step (3), the UE decodes the SIB (or similar message) to determine if it contains some of the following information, as described above:
NCR SSB puncture patterns;
NCR GNSS coordinates;
NCR Polarization variations.

It is noted that at this point the UE is aware there is at least one NTN-NCR in the coverage area of the cell, but since NTN cells are large (50 km diameter or more) the UE will not know if it is sufficiently close to an NTN-NCR to communicate via it. If the UE is aware of its own location it can compare with the broadcasted NTN-NCR GNSS coordinates, but at least some example embodiments avoid this power consuming step.

In step (4), the UE will utilize one or more of the following techniques to identify the presence of an NTN-NCR, which will be described in more details later on:
SSB power variations;
SSB PDP variations;
SSB polarization variations.

In step (5), the UE will monitor the SSB pattern and utilize one or more of the techniques from Step (4) to determine if it's connecting via an NTN-NCR.

If the UE determines that it's connected via an NTN-NCR (yes in step (5)), the procedure advances to Step (6).

If the UE determines that it's not connected via an NTN-NCR (no in step (5)), the procedure advances to Step (7).

In step (6), the UE determines if it has received the GNSS coordinates for the identified NTN-NCR.

If the GNSS coordinates of the NTN-NCR are known (yes in step (6)), the procedure advances to Step (8).

If the GNSS coordinates of the NTN-NCR are not known (no in step (6)), the procedure advances to Step (7).

In Step (7), if an NTN-NCR was not identified or the GNSS coordinates of an identified NTN-NCR was not received, the UE will have to rely on legacy NTN connection procedure and its own GNSS coordinates.

In Step (8), the UE has identified an NTN-NCR and its GNSS coordinates and can now perform NTN connection procedure via the NTN-NCR using the GNSS coordinates of the NTN-NCR.

According to at least some example embodiments, an NTN UE is enabled to identify the presence of an NTN-NCR by one or more of the following methods:
Linking specific known puncturing patterns to the power variations of received SSB bursts;
Linking specific known puncturing patterns to the PDP variations of received SSB bursts;
Linking specific known puncturing patterns to the Polarization variations of received SSB bursts.

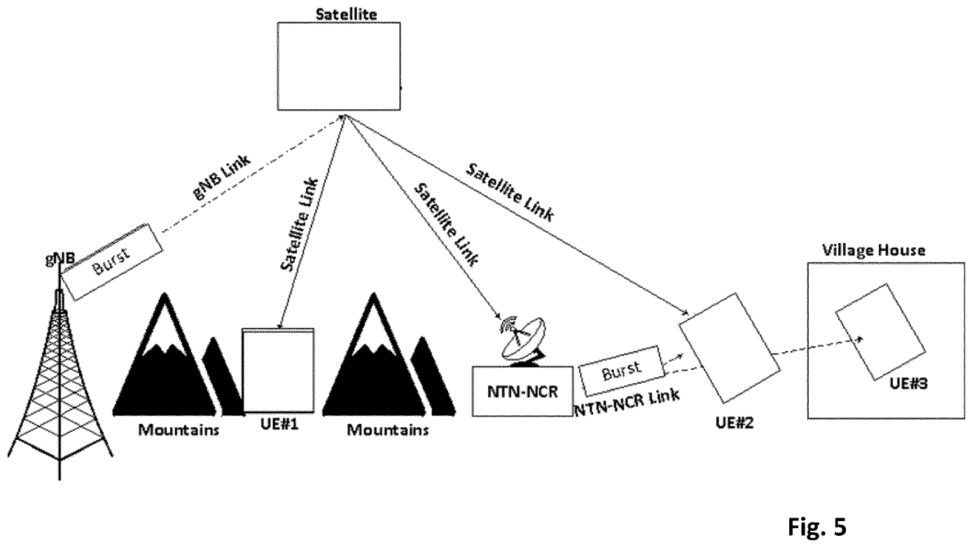

These three techniques to detect the presence of an NTN-NCR will be described in more details in the following. The nuances of the usage of these techniques depend on the characteristics of the scenario. There are 3 possible scenarios to be considered, which are also illustrated in FIG. 5.

In a first scenario illustrated in FIG. 5, UE #1 is located in a mountain valley with no NTN-NCR coverage and will only receive NTN SSBs from the satellite link (this is considered the legacy operation).

In a second scenario, UE #2 is outside in a mountain village, which is covered by an NTN-NCR and will be able to receive NTN SSBs from both the satellite link and the NTN-NCR link.

In a third scenario, UE #3 is inside a building in a mountain village, which is covered by an NTN-NCR and will only be able to receive NTN SSBs from the NTN-NCR link.

### Detection of SSB Puncturing Patterns Using Power Level Variations

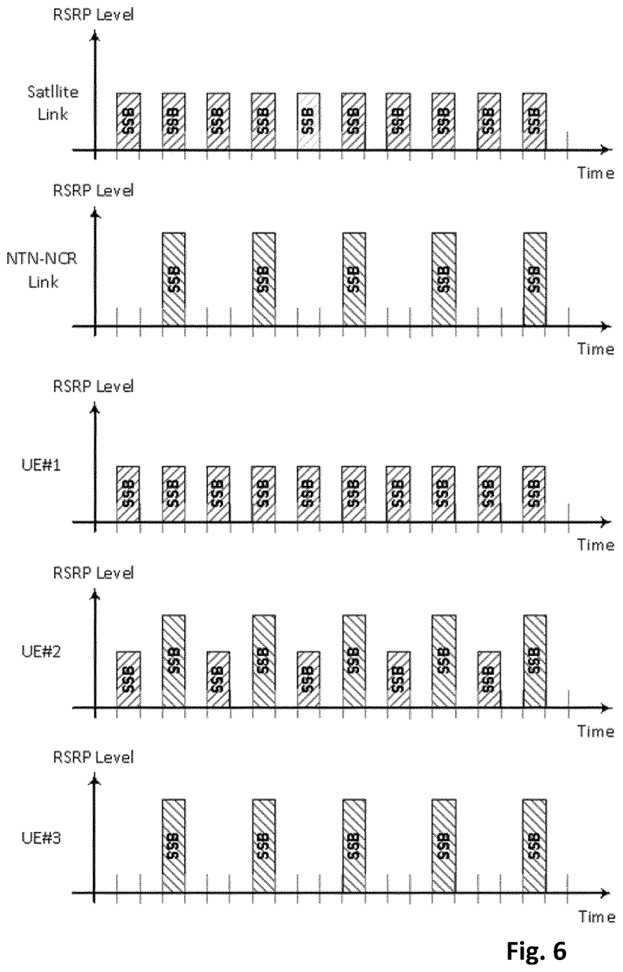

The power level of the NTN SSBs repeated by the NTN-NCR will be higher for UEs close to the NTN-NCR, whereby the change in received power level of the SSB signals can be used to detect the puncturing pattern and identify the presence of a specific NTN-NCR. This is illustrated in FIG. 6 for the three use cases (three scenarios), where UE #2 and UE #3 will detect the NTN-NCR and rely on the GNSS coordinates of the NTN-NCR. As such, UE #2 and UE #3 will be able to connect via NTN even though it is out of GNSS coverage or if it's not implemented with a GNSS receiver, and thereby doesn't know its own location.

### Detection of SSB Puncturing Patterns Using PDP Variations

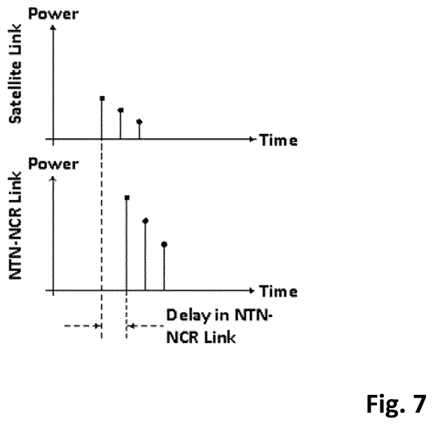

The PDP of the NTN SSBs repeated by the NTN-NCR will be slightly delayed compared to those received directly from the satellite, due to the added distance of the NTN-NCR link, as illustrated in FIG. 7. This detection method requires that the UE can receive both the NTN satellite link and the NTN-NCR link, so only valid for use case #2 (second scenario).

The puncturing pattern is detected by correlating those delay differences to the puncturing patterns, as shown in Table 1, for the second use case (second scenario), where rt is the reference time of the received SSB from the satellite.

TABLE 1

| | Relative Delay of the Received SSB [ns] | | | | | | | |
|---|---|---|---|---|---|---|---|---|
| | 1^{st} | 2^{nd} | 3^{rd} | ^{4th} | 5^{th} | 6^{th} | 7^{th} | 8^{th} |
| | SSB | SSB | SSB | SSB | SSB | SSB | SSB | SSB |
| UE#2 | rt | rt + x | rt | rt + x | rt | rt + x | rt | rt + x |

The delay difference between the SSB received from the satellite and the NCR can of course be very small if the UE is located very close to the NCR. Only UEs with very high sampling rates will be able to use this technique to detect the presence of a NCR, other UEs will have to rely on one or both of the other techniques.

### Detection of SSB Puncturing Patterns Using Polarization Variations

The polarization of the received NTN SSBs can also be used to detect an NTN-NCR, assuming that the satellite and NTN-NCR use different polarizations. As such, if the satellite is using circular polarization then the NTN-NCR can be configured for linear polarization or vice versa.

The puncturing pattern is detected by correlating those polarization differences to the puncturing patterns, as shown in Table 2, for the three different use cases (scenarios). Use case #1 & #3 (the first and third scenarios) requires that polarization information of the satellite and/or NTN-NCR is included in the MIB/SIB.

TABLE 2

| | Polarization of the Received SSB | | | | | | | |
|---|---|---|---|---|---|---|---|---|
| | 1^{st} | 2^{nd} | 3^{rd} | ^{4th} | 5^{th} | 6^{th} | 7^{th} | 8^{th} |
| | SSB | SSB | SSB | SSB | SSB | SSB | SSB | SSB |
| UE#1 | Circular | Circular | Circular | Circular | Circular | Circular | Circular | Circular |
| UE#2 | Circular | Linear | Circular | Linear | Circular | Linear | Circular | Linear |
| UE#3 | — | Linear | — | Linear | — | Linear | — | Linear |

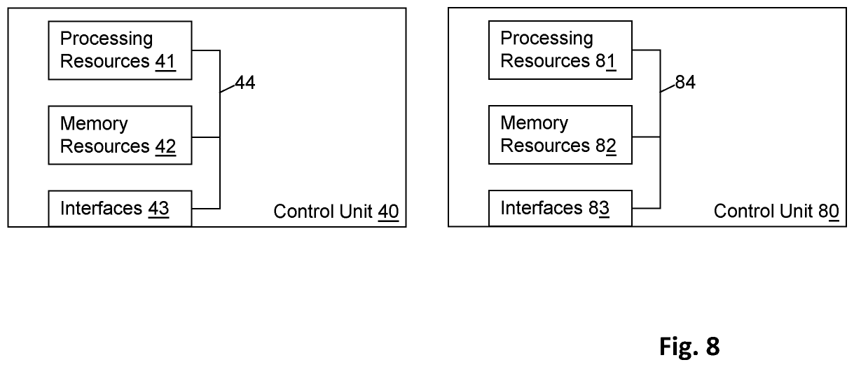

Now reference is made to FIG. 8 illustrating a simplified block diagram of control units 40, 80 that are suitable for use in practicing at least some example embodiments. According to an implementation example, process 1 of FIG. 1 is implemented by the control unit 40, and process 2 of FIG. 1 is implemented by the control unit 80.

The control unit 40 comprises processing resources (e.g. processing circuitry) 41, memory resources (e.g. memory circuitry) 42 and interfaces (e.g. interface circuitry) 43, which are coupled via a wired or wireless connection 44.

The control unit 80 comprises processing resources (e.g. processing circuitry) 81, memory resources (e.g. memory circuitry) 82 and interfaces (e.g. interface circuitry) 83, which are coupled via a wired or wireless connection 84.

According to an example implementation, the memory resources 42, 82 are of any type suitable to the local technical environment and are implemented using any suitable data storage technology, such as semiconductor based memory devices, magnetic memory devices and systems, optical memory devices and systems, fixed memory and removable memory. The processing resources 41, 81 are of any type suitable to the local technical environment, and include one or more of general purpose computers, special purpose computers, microprocessors, digital signal processors (DSPs) and processors based on a multi core processor architecture, as non-limiting examples.

According to an implementation example, the memory resources 42, 82 comprise one or more non-transitory computer-readable storage media which store one or more programs that when executed by the processing resources 41, 81 cause the control unit 40, 80 to function as a base station of a non-terrestrial access network as described above.

Generally, mobile devices may be user equipments (UE) such as cellular phones, smart phones, laptop's, handhelds, tablets, vehicles, or the like. A mobile device may also be a module, a modem on module, a system in package or a system on chip which can be connected to or inserted in a user equipment. The user equipment may be fixed shape or it may be used in different form factors.

Further, as used in this application, the term “circuitry” refers to one or more or all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to at least some example embodiments, an apparatus of a non-terrestrial radio access network is provided, the apparatus comprising:
means for assigning a signature to one or more repeater devices after the one or more repeater devices had been connected to the apparatus; and
means for broadcasting position information regarding a position of the one or more repeater devices and an indication of the signature of the one or more repeater devices.

According to at least some example embodiments, a user equipment is provided, the user equipment comprising:
means for detecting at least one specific variation regarding bursts received by the user equipment;
means for comparing one or more predetermined signatures to the at least one specific variation; and
means for, in case a predetermined signature of the one or more predetermined signatures corresponds to the at least one specific variation, identifying a connection to a non-terrestrial radio access network via a repeater device that has been assigned the predetermined signature.

It is to be understood that the above description is illustrative and is not to be construed as limiting the scope of protection. Various modifications and applications may occur to those skilled in the art without departing from the true spirit and scope as defined by the appended claims.

1-10. (canceled)

11. A method for use by a user equipment, the method comprising:
detecting at least one specific variation regarding bursts received by the user equipment;
comparing one or more predetermined signatures to the at least one specific variation; and
in case a predetermined signature of the one or more predetermined signatures corresponds to the at least one specific variation, identifying a connection to a non-terrestrial radio access network via a repeater device that has been assigned the predetermined signature.

12. The method of claim 11, wherein the at least one specific variation comprises at least one out of the following: power variation, power delay profile variation, and polarization variation.

13. The method of claim 12, comprising:
in case the specific variation is the power variation of bursts, detecting the predetermined signature based on a change in received power level of the bursts;
in case the specific variation is the power delay profile variation, detecting the predetermined signature by correlating delay differences between the bursts to the one or more predetermined signatures; and
in case the specific variation is the polarization variation, detecting the predetermined signature based on a polarization of the bursts.

14. The method of claim 11, wherein the bursts are associated with at least one out of the following: full slots, subframes, symbols, a bandwidth part, a subset of bandwidth parts or any downlink reference structure comprising at least one of synchronization signal blocks, primary synchronization signals, secondary synchronization signals, or channel status information.

15. The method ofclaim 11, wherein at least one of the following applies:
each of the one or more predetermined signatures comprises a pattern of downlink transmissions to be performed, by the repeater device that has been assigned the predetermined signature, as repetitions of transmissions which are received by the repeater device from an apparatus of the non-terrestrial radio access network;
the predetermined signature comprises an on/off pattern of the downlink transmissions;
the on/off pattern is associated with at least one of full slots, subframes, symbols, a bandwidth part, a subset of bandwidth parts or any downlink reference structure comprising at least one of synchronization signal blocks, primary synchronization signals, secondary synchronization signals, or channel status information; or
each of the one or more predetermined signatures comprises a sequence of downlink transmissions to be performed, by the repeater device that has been assigned the predetermined signature, as repetitions of transmissions which are received by the repeater device from an apparatus of the non-terrestrial radio access network, wherein, according to the sequence, in some predefined occasions, the repetitions are to be turned off.

16-17. (canceled)

18. An apparatus of a non-terrestrial radio access network, the apparatus comprising at least one processor and at least one memory including computer program code, the at least one memory and the computer program code configured to, with the at least one processor, cause the apparatus at least to:
assign a signature to one or more repeater devices after the one or more repeater devices had been connected to the apparatus; and
broadcast position information regarding a position of the one or more repeater devices and an indication of the signature of the one or more repeater devices.

19. The apparatus of claim 18, wherein the signature is unique for each of the one or more repeater devices associated with the apparatus.

20. The apparatus of claim 18, wherein the signature comprises a pattern of downlink transmissions to be performed, by the one or more repeater devices, as repetitions of transmissions which are received by the one or more repeater devices from the apparatus.

21. The apparatus of claim 18, wherein the signature comprises an on/off pattern of downlink transmissions for each of the one or more repeater devices.

22. The apparatus of claim 18, wherein the signature, for each of the one or more repeater devices, comprises an on/off pattern of downlink transmissions to be performed, by the one or more repeater devices, as repetitions of transmissions which are received by the one or more repeater devices from the apparatus, the on/off pattern being associated with at least one of full slots, subframes, symbols, a bandwidth part, a subset of bandwidth parts or any downlink reference structure comprising at least one of synchronization signal blocks, primary synchronization signals, secondary synchronization signals, or channel status information.

23. The apparatus of claim 18, wherein the signature, for each of the one or more repeater devices, comprises a sequence of downlink transmissions to be performed, by the one or more repeater devices, as repetitions of transmissions which are received by the one or more repeater devices from the apparatus, wherein, according to the sequence, in some predefined occasions, the repetitions are to be turned off.

24. The apparatus of claim 18, wherein the indication comprises a list of the repeater devices each associated with its position information and unique signature.

25. The apparatus of claim 18, wherein at least one of the following applies:
the one or more repeater devices comprise a radio frequency signal repeater;
the one or more repeater devices comprise an analog repeater;
the one or more repeater devices are terrestrial;
the one or more repeater devices are stationary and the position information comprises a single position;
the one or more repeater devices are moving and the position information comprises at least one position and a time corresponding to the at least one position; or
the one or more repeater devices are for providing repetitions of transmissions.

26. The apparatus of claim 18, wherein the at least one memory and the computer program code are configured to, with the at least one processor, cause the apparatus further to at least one of the following:
obtain the position of the one or more repeater devices;
obtain the position of the one or more repeater devices directly from the one or more repeater devices;
obtain the position of the one or more repeater devices via a core network;
obtain the position of the one or more repeater devices via a location and management function of a core network;
determine the position of the one or more repeater devices based on positioning methods;
determine the position of the one or more repeater devices based on observed time difference on arrival, OTDOA;
receive an update of the position from the one or more repeater devices;
configure the one or more repeater devices, when the one or more repeater devices are being connected to the apparatus;
configure the signature for the one or more repeater devices, when the one or more repeater devices are being connected to the apparatus; or
configure the one or more repeater devices, when the one or more repeater devices are being connected to the apparatus, by setting a transmission power of repetitions, to be performed by the one or more repeater devices, of transmissions which are received by the one or more repeater devices, towards the apparatus and one or more user equipments.

27. The apparatus of claim 18, wherein the at least one memory and the computer program code are configured to, with the at least one processor, cause the apparatus further to:
broadcast polarization information regarding a polarization configuration associated with the one or more repeater devices.

28. A user equipment comprising at least one processor and at least one memory including computer program code, the at least one memory and the computer program code configured to, with the at least one processor, cause the user equipment at least to:
detect at least one specific variation regarding bursts received by the user equipment;
compare one or more predetermined signatures to the at least one specific variation; and
in case a predetermined signature of the one or more predetermined signatures corresponds to the at least one specific variation, identify a connection to a non-terrestrial radio access network via a repeater device that has been assigned the predetermined signature.

29. The user equipment of claim 28, wherein the at least one specific variation comprises at least one out of the following: power variation, power delay profile variation, and polarization variation.

30. The user equipment of claim 29, wherein the at least one memory and the computer program code are configured to, with the at least one processor, cause the user equipment further to:
in case the specific variation is the power variation of bursts, detect the predetermined signature based on a change in received power level of the bursts;
in case the specific variation is the power delay profile variation, detect the predetermined signature by correlating delay differences between the bursts to the one or more predetermined signatures; and
in case the specific variation is the polarization variation, detect the predetermined signature based on a polarization of the bursts.

31. The user equipment of claim 28, wherein the bursts are associated with at least one out of the following: full slots, subframes, symbols, a bandwidth part, a subset of bandwidth parts or any downlink reference structure comprising at least one of synchronization signal blocks, primary synchronization signals, secondary synchronization signals, or channel status information.

32. The user equipment of claim 28, wherein at least one of the following applies:
each of the one or more predetermined signatures comprises a pattern of downlink transmissions to be performed, by the repeater device that has been assigned the predetermined signature, as repetitions of transmissions which are received by the repeater device from an apparatus of the non-terrestrial radio access network;
the predetermined signature comprises an on/off pattern of the downlink transmissions;
the on/off pattern is associated with at least one of full slots, subframes, symbols, a bandwidth part, a subset of bandwidth parts or any downlink reference structure comprising at least one of synchronization signal blocks, primary synchronization signals, secondary synchronization signals, or channel status information; or
each of the one or more predetermined signatures comprises a sequence of downlink transmissions to be performed, by the repeater device that has been assigned the predetermined signature, as repetitions of transmissions which are received by the repeater device from an apparatus of the non-terrestrial radio access network, wherein, according to the sequence, in some predefined occasions, the repetitions are to be turned off.
